(19) United States
(12) Patent Application Publication
(10) Pub. No.: US 2011/0029435 A1
(43) Pub. Date: Feb. 3, 2011

(54) SYSTEMS AND METHODS FOR DISTRIBUTING ELECTRONIC CONTENT

(76) Inventors: Ron Ronen, Atlantic Beach, NY (US); Elliot Rami Ronen, Atlantic Beach, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 12/845,493

(22) Filed: Jul. 28, 2010

Related U.S. Application Data
(60) Provisional application No. 61/229,243, filed on Jul. 28, 2009.

(51) Int. Cl. G06F 17/30; G06Q 30/00; H04L 9/28; H04L 9/00

(52) U.S. Cl. 705/53; 705/34; 707/705; 713/165; 707/E17.01; 707/E17.032

(57) ABSTRACT

A system for distributing electronic content may include a content repository including one or more electronic content items. The content repository may be in communication with one or more content databases. The system may include a user interface in communication with the content repository. The user interface may be configured to receive a selection from a content administrator of one or more electronic content items available from the one or more content databases, and one or more end users to whom the selected electronic content items are assigned. The system may include one or more end user devices in communication with the content repository. Each end user device may be associated with an end user and an end user account. Each end user device may be configured to receive the selected electronic content items that are assigned to the corresponding end user from the content repository.

### CROSS REFERENCE TO RELATED APPLICATIONS

This application claims priority under 35 U.S.C. § 119(e) to U.S. Provisional Application No. 61/229,243, filed Jul. 28, 2009, which is incorporated by reference herein in its entirety.

### BACKGROUND

Not Applicable

Electronic content in the form of text, video, audio and other multimedia is widely available on the Internet. Some electronic content is free to end users, while other electronic content is only provided to paying subscribers. In academic environments, however, educational content is generally provided as printed publications.

Printed publications, such as educational textbooks, are typically costly and difficult to transport. In addition, readers are unable to annotate the content without defacing the material and are unable to quickly search content for key words or phrases.

Generally, students purchase textbooks from an academic institution for each of their classes. At the end of the term, the students elect whether to retain the purchased books or resell them, usually at a substantial loss. Textbook publishers also face difficulty in estimating the number of professionally bound copies to print to avoid incurring costs for overprinting. In addition, all changes must be finalized well in advance of printing to allow time for the typesetting and publishing processes.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In an embodiment, a system for distributing electronic content may include a content repository including one or more electronic content items. The content repository may be in communication with one or more content databases. The system may include a user interface in communication with the content repository. The user interface may be configured to receive a selection from a content administrator of one or more electronic content items available from the one or more content databases, and one or more end users to whom the selected electronic content items are assigned. The system may include one or more end user devices in communication with the content repository. Each end user device may be associated with an end user and an end user account. Each end user device may be configured to receive the selected electronic content items that are assigned to the corresponding end user from the content repository.

In an embodiment, a system of distributing electronic content may include a content repository including one or more electronic content items. The content repository may be in communication with one or more content databases. The system may include an end user device in communication with the content repository, where the end user device may be associated with an end user and an end user account. The end user device may be configured to receive selected electronic content items from the content repository. The selected electronic content items may be assigned to the end user by a content administrator.

In an embodiment, a system for distributing electronic content may include a content repository including one or more educational electronic content items. The content repository may be in communication with one or more content databases. The system may include a contributor content repository including one or more electronic content items supplied by one or more professors that do not require a license, and a user interface in communication with the content repository and the contributor content repository. The user interface may be configured to receive a selection from a professor of one or more educational electronic content items available from one or more of the content databases and the contributor content repository, and one or more students to whom the selected electronic content items are assigned. The system may include one or more end user devices in communication with the content repository and the contributor content repository. Each end user device may be associated with a student and a student account. Each end user device may be configured to receive the selected educational electronic content items that are assigned to the corresponding student from one or more of the content repository and the contributor content repository.

In an embodiment, a system for distributing electronic content may include a content repository comprising one or more electronic content items. The content repository may be in communication with one or more content databases. The system may include a user interface in communication with the content repository. The user interface may be configured to receive a selection from a content administrator of one or more electronic content items available from the one or more content databases, and one or more end users to whom the selected electronic content items are assigned. The content repository may be configured to transmit the selected content items to one or more end user devices.

### BRIEF DESCRIPTION OF THE DRAWINGS

Aspects, features, benefits and advantages of the present invention will be apparent with regard to the following description and accompanying drawings, of which:

FIG. 1 illustrates an exemplary system for distributing electronic content according to an embodiment.

FIG. 2 illustrates an exemplary method of selecting electronic content according to an embodiment.

FIG. 3 illustrates an exemplary method of distributing one or more updates to electronic content according to an embodiment.

FIG. 4 illustrates exemplary annotated text according to an embodiment.

FIG. 5 illustrates exemplary end user devices operating in shared mode according to an embodiment.

FIG. 6 illustrates an exemplary method of using the home system according to an embodiment.

FIG. 7 illustrates an exemplary method of purchasing electronic content from an online store according to an embodiment.

FIG. 8 illustrates an exemplary method of distributing electronic content using a contributor device according to an embodiment.

FIG. 9 illustrates an exemplary method of tracking attendance according to an embodiment.

FIG. 10 depicts a block diagram of exemplary internal hardware that may be used to contain or implement program instructions according to an embodiment.

### DETAILED DESCRIPTION

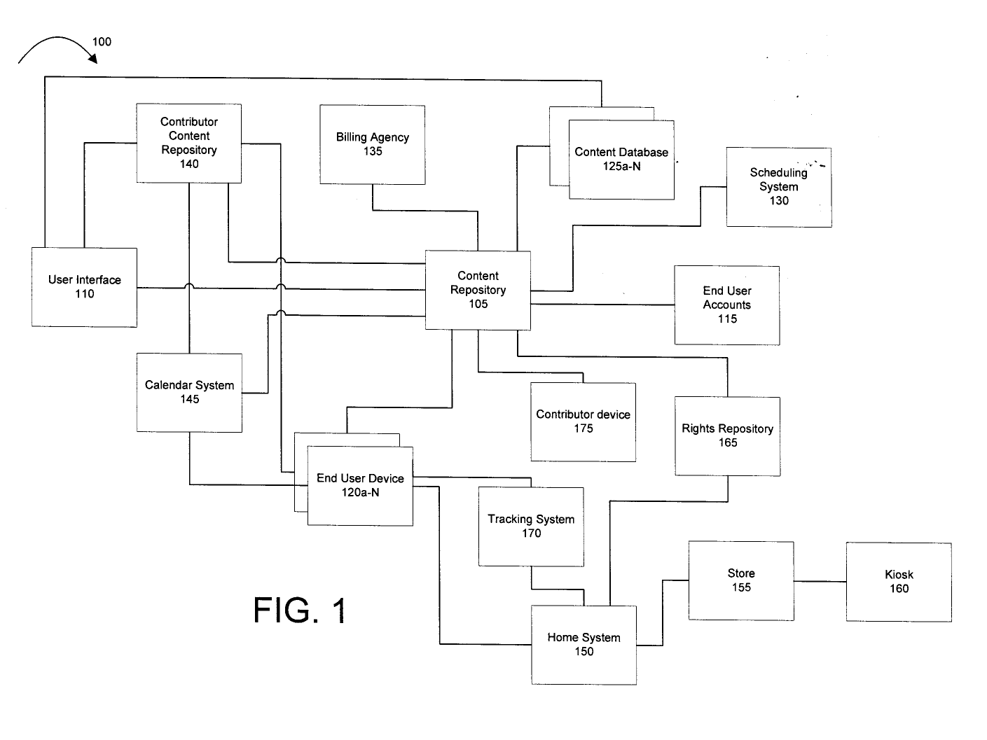

FIG. 1 illustrates an exemplary system for distributing electronic content to a user device according to an embodiment. As illustrated by FIG. 1, the system 100 may include a content repository 105, a user interface 110, and/or one or more end user devices 120a-N.

In an embodiment, a content repository 105 may be a storage medium or a portion thereof that is capable of storing electronic data. For example, a content repository 105 may be one or more databases or other storage medium, such as RAM or ROM, of a computing device, a server and/or the like. In an embodiment, a content repository 105 may be one or more databases or other storage medium, such as RAM or ROM, that is in communication with a computing device, a server and/or the like. In an embodiment, the content repository 105 may be configured to be augmented with additional storage capacity so that modular capacity may be added as needed.

In an embodiment, a content repository 105 may store a variety of forms of electronic content items. Electronic content items may be digital content that can be transferred over a network, such as the Internet, an intranet, a local access network (LAN) and/or the like. For example, electronic content items may include digital versions of textbooks, articles, periodicals, syllabi, photographs, images, audio files, video files and/or the like. In an embodiment, electronic content may include portions of textbooks and/or articles, including but not limited to certain chapters, paragraphs, page ranges and/or the like.

In an embodiment, a content repository 105 may include paid electronic content and/or free electronic content. Paid electronic content may include electronic content that can only be used for a fee. In an embodiment, a license may be needed to use paid electronic content. In an embodiment, free electronic content may include electronic content that can be used by an end user at no cost.

Paid and/or free electronic content may be provided by one or more content databases 125a-N. For example, paid electronic content may be provided by one or more commercially available content databases, local databases such as those belonging to the owner of the system, such as an educational institution, a corporation, an organization and/or the like, or any other similar source. Free electronic content may be provided from freely available third party databases, local databases, websites, file servers and/or the like.

In an embodiment, the content repository may be in communication with one or more content databases 125a-N. Paid and/or free electronic content may be transferred from one or more content databases 125a-N to the content repository 105 electronically via a network. In an embodiment, the content repository 105 may maintain login information for one or more content databases 125a-N. In an embodiment, login information may be information required to access a content database 125a-N. Login information may include a user name, a password, a biometric, or other identifying information. A content repository 105 may use this login information to automatically access one or more content databases 125a-N, and download one or more electronic content items. As such, a content repository 105 may include any combination of paid and free electronic content that is provided from a variety of sources.

In an embodiment, electronic content may be contributed to the content repository 105 by one or more system administrators. For example, in an educational context, an administrator, such as a professor, a dean, an administrative employee and/or the like may contribute one or more documents that are relevant to the educational institution, including but not limited to a student handbook, rules and regulations and/or the like. In a corporate environment, an administrator, such as a manager, an information technology employee and/or the like may contribute electronic content such as work-related documents, a project, department-related documents, corporate policies, an employee manual and/or the like. As another example, an administrator may contribute electronic content relevant to the operation of the system such as user device manuals, tutorials, troubleshooting documentation and/or the like.

In an embodiment, a content repository 105 may be in communication with a scheduling system 130. For example, in an educational environment, a content repository 105 may be in communication with a class scheduling system 130 for a school, college, university and/or the like. A content repository 105 may receive class schedules for one or more students from a scheduling system 130, and may use these class schedules to identify classes, study groups, organizations and/or the like to which the students belong.

For example, a content repository 105 may receive a class schedule for Student A. The content repository 105 may compare Student A′s class list with a list of study groups corresponding to one or more classes. In an embodiment, a list of study groups may be stored in the content repository 105. In an embodiment, a list of study groups may be received from a scheduling system 130 or other storage medium. For example, the content repository 105 may identify that Student A is enrolled in History 101, which has a corresponding study group that meets every Monday at 7 pm.

In an embodiment, a content repository 105 may be in communication with a billing agency 135. A billing agency 135 may be a department, an entity, an organization and/or the like that manages invoicing and billing of charges. A billing agency may be a university's bursar's office, a company's accounting department and/or the like. The content repository 105 may transmit a charge, a bill, an invoice and/or the like for fees associated with use of electronic content. For example, a certain electronic textbook may require the purchase of a license. The content repository 105 may purchase any necessary licenses, and may forward the charge for such licenses to a bursar's financial system for billing and/or payment by the educational institution, the associated end user student and/or the like.

In an embodiment, a contributor content repository 140 may be a storage medium or portion thereof that is capable of storing electronic data. For example, a contributor content repository 140 may be one or more databases or other storage medium, such as RAM or ROM, of a computing device, a server and/or the like. In an embodiment, a contributor content repository 140 may be one or more databases or other storage medium, such as RAM or ROM, that is in communication with a computing device, a server and/or the like. In an embodiment, a contributor content repository 140 may be part of the content repository 105. Alternatively, the contributor content repository 140 may be located separately from the content repository 105. In an embodiment, a contributor content repository 140 may be configured to be augmented with additional storage capacity so that modular capacity may be added as needed.

In an embodiment, a contributor content repository 140 may include free electronic content that is provided by one or more content administrators. A content administrator may be any person who has the right to select and/or distribute electronic content to one or more end users. A content administrator may include a professor, a teaching assistant, a dean, a manager, an employee and/or the like.

In an embodiment, free electronic content may include electronic content that is developed by one or more content administrators. For instance, a syllabus, example problems, quizzes, tests and/or the like that are created by a professor may be examples of free electronic content that may be stored in a contributor content repository 140. In an embodiment, free electronic content may have a variety of formats including, but not limited to Microsoft Word documents, Adobe PDF documents and/or the like.

In an embodiment, a content administrator may upload free electronic content to the contributor content repository 140 via the user interface 110. In an embodiment, the contributor content repository 140 may prohibit a content administrator from uploading protected content, such as an electronic content item that requires payment of a license fee. For example, a professor may be prohibited from uploading an entire textbook to the contributor content repository 140 without paying a required license fee. In an embodiment, electronic content that is uploaded to the contributor content repository 140 may be scanned to determine whether the electronic content is subject to a license or other limitation. In an embodiment, the electronic content may be scanned by an application on the contributor content repository 140. In an embodiment, the electronic content may be scanned by an application located remotely from the contributor content repository 140. In an embodiment, at least a portion of the scanned electronic content may be compared with a list of licensed electronic content from the content repository 105. If the scanned electronic content corresponds to one or more licensed items of electronic content, the contributor content repository 140 may prohibit the scanned electronic content from being uploaded. In an embodiment, if the scanned electronic content does not correspond to one or more licensed items of electronic content, the contributor content repository 140 may allow the scanned electronic content to be uploaded.

In an embodiment, the contributor content repository 140 may determine whether an electronic content item can be uploaded to the contributor content repository based on attributes of the electronic content item. For example, the contributor content repository may prohibit files having a certain size, number of pages and/or the like from being uploaded. The contributor content repository 140 may include an indication of an allowable file size, number of pages and/or the like to which the electronic content item to be uploaded is compared. For example, the contributor content repository 140 may include a file or other data type that indicates only files having a size less than 50 pages may be uploaded. In an embodiment, the contributor content repository may prohibit certain types of files from being uploaded to the contributor content repository. The contributor content repository 140 may include an indication of an allowable file type to which the electronic content item to be uploaded is compared. For example, the content contributor repository 140 may prohibit uploading of Adobe files. As such, the system 100 may prevent uploading of pirated or unauthorized material by content administrators.

A content administrator may select one or more items of free electronic content that he or she has uploaded via the user interface 110. In an embodiment, a content administrator may select one or more end users and/or groups of end users to whom the selected electronic content item is to be distributed. The contributor content repository 140 may transmit the selected electronic content to the end user device 120a-N of one or more of the selected end users via a network.

In an embodiment, an end user device 120a-N may be a computing device configured to display information on a screen or other display interface of the end user device. In an embodiment, the display interface may be configured to display textbook pages, chapters, articles, journals, videos and/or the like at full size with no scaling or page layout adjustment. An end user device 120a-N may be transportable, such as a mobile computing device. For example, an end user device 120a-N may be a mobile telephone, a media player, a notebook computing device, a laptop computing device and/or another type of mobile computing device.

In an embodiment, the display of an end user device 120a-N may utilize light-emitting diode (LED), organic light-emitting diode (OLED), liquid crystal display (LCD), e-ink technology or any combination thereof. In an embodiment, an end user device 120a-N may be connected to a network via a wired and/or a wireless interface. Wired interfaces may include but are not limited to a bus, a universal serial bus (USB), Ethernet, eSATA and/or the like. In an embodiment, a USB port may be used to configure or troubleshoot an end user device. Wireless interfaces may include, but are not limited to those that allow connectivity to wireless networks, cellular wireless networks, Bluetooth networks and/or the like. In an embodiment, an end user device 120a-N may communicate with other end user devices, computing devices and/or auxiliary devices such as a mouse, a keyboard and/or the like via a wired and/or wireless interface. In an embodiment, an end user device 120a-N may include an operating system and/or a web browser.

In an embodiment, an end user device 120a-N may include onboard flash storage, hard drive space and/or solid state storage means to store downloaded electronic content on the single end user device. An end user device 120a-N may support a variety of file formats including but not limited to ebook formats, PDF and Microsoft Word documents, and image files such as jpeg files.

In an embodiment, each end user may have an associated end user account 115. An end user account may be a storage medium or a portion thereof that is capable of storing data associated with an end user. For example, an end user account 115 may be one or more databases or other storage medium, such as RAM or ROM, of a computing device, a server and/or the like. In an embodiment, an end user account 115 may be one or more databases or other storage medium, such as RAM or ROM, that is in communication with a computing device, a server and/or the like. In an embodiment, one or more end user accounts 115 may be stored in the same database, storage medium and/or the like as the content repository 105. In an embodiment, one or more end user accounts 115 may be stored in a database, storage medium and/or the like in communication with the content repository 105.

In an embodiment, an end user may be a person for by whom electronic content is intended to be used. For example, in an educational context, an end user may be a student. In a corporate environment, an end user may be an employee. In an embodiment, an end user account 115 may be unique to the end user to which it corresponds. Each end user account 115 may store a unique identifier associated with the end user to which the account corresponds. For example, an end user account 115 may store a unique alphanumeric code that identifies an end user. In an embodiment, an end user account may not include end user identifying information such as an end user's name, social security number, birth date and/or the like. In an embodiment, the system may use the unique identifier to access information from other sources regarding the end user. For example, the content repository may use the unique identifier to access a class schedule associated with a specific end user.

In an alternate embodiment, an end user account may include end user identifying information. For example, an end user account may include information identifying a student such as the student's name, social security number, birth date and/or one or more identification numbers corresponding to other administrative databases, such as the bursar's office, the registrar's office and/or the like.

In an embodiment, each end user account may be linked to only one end user device 120a-N at a time. In an embodiment, each end user device 120a-N may have a corresponding identification number, and this number may be associated with the end user's account. In an embodiment, if an end user device 120a-N is lost, stolen or becomes inoperable, the electronic content associated with an end user may be transferred to a different end user device. For example, as described above, the content repository 105 may store an indication of which electronic content was assigned to which end user. In an embodiment, the content repository 105 may store one or more unique identifiers associated with end users, and the electronic content assigned to the end users. The electronic content that has been assigned to the end user of a lost, stolen or inoperable end user device 120a-N may be transferred to a new end user device.

In an embodiment, a user interface 110 may allow one or more content administrators to access the system 100. The user interface 110 may be implemented by software residing on a computing device, such as a desktop computer, a laptop computer, a notebook computer, a mobile computing device, such as a mobile telephone or a personal digital assistant, and/or the like. In an embodiment, the user interface 110 may be a web interface that is accessible from a networked computing device at almost any location. In an embodiment, the user interface 110 may be in communication with the content repository 105 and/or the contributor content repository 140 via a network.

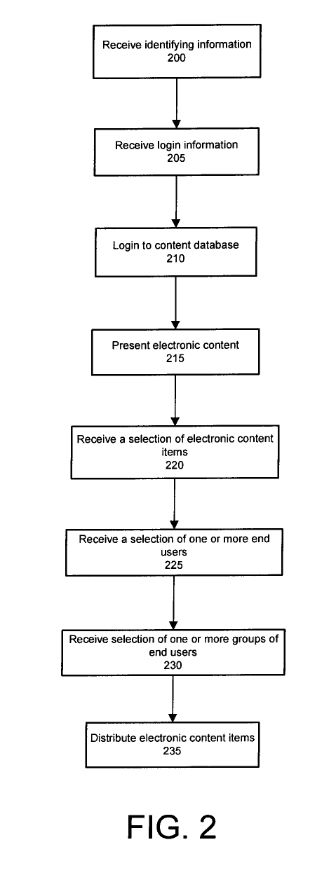

FIG. 2 illustrates an exemplary method of selecting electronic content according to an embodiment. In an embodiment, a content administrator may log in to the system 100 via the user interface 110. The user interface 110 may receive 200 identifying information from a content administrator, such as a login name, a password, a biometric and/or the like. In an embodiment, verification of the received identifying information may be performed by a web server and/or other computing device. The web server may compare the received identifying information with user information stored on the web server. If the information matches, the web server may authorize login. For example, a professor may login by providing a username and a password. This information may be transmitted to a web server and compared to information stored thereon. The web server may determine whether the username is valid by comparing the received username with a list of valid usernames. If the username is not identified on the list, the web server may deny access. If the username is included in the list, the web server may determine whether the received password corresponds to the password associated with the username. If so, access may be granted. Otherwise, access may be denied.

In an embodiment, the user interface 110 may receive 205 login information from a content administrator to access one or more content databases 125a-N from which electronic content is to be received. For example, a professor may wish to select an electronic article that currently resides on a university file server for distribution to his class. The user interface may receive 205 login information from the professor, such as a username and password, to access the file server. Alternatively, as described above, the content repository 105 may automatically login 210 to one or more content databases 125a-N, in which case a content administrator may not be required to provide login information.

In an embodiment, the user interface 110 may present 215 at least a portion of the electronic content available in the content repository 105, one or more content databases 125a-N, and/or the contributor content repository 140 to a content administrator. The electronic content may be presented 215 in a list format, or organized in various ways such as alphabetically by title, by author, by subject and/or the like. In an embodiment, electronic content may be organized by the nature of the curriculum to which the electronic content relates, the availability of the electronic content from publishers and/or the like.

In an embodiment, the user interface 110 may receive 220 a selection from a content administrator of one or more electronic content items from the content repository 105, one or more content databases 125a-N and/or the contributor content repository 140 for distribution to one or more end users. For example, a user interface may receive 220 a selection from a professor of textbooks, articles and/or other content relating to his or her course for distribution to the students in the professor's course. In an embodiment, a price associated with one or more pieces of electronic content may be displayed to a content administrator via the user interface 110. A content administrator may make a selection by way of a mouse, a keyboard, a touch screen or other input device. For example, a content administrator may select one or more pieces of electronic content using a mouse to highlight the selected pieces on the user interface 110. In an embodiment, the user interface 110 may receive 225 a selection from a content administrator of one or more end users to receive the selected electronic content. For example, a professor may select specific students from a list of students provided by the user interface to receive the selected electronic content.

In an embodiment, the user interface 110 may receive 230 a selection from a content administrator of one or more groups of end users to receive the selected content. A group may be a certain class, a team, a study group, an organization, a corporate division, and/or other group of end users. For example, a professor may select a specific class, such as “History 101,” to receive the selected electronic content. In an embodiment, a group may be populated with information identifying end users associated with that group, such as names, identification numbers and/or the like. In an embodiment, the list of end users and/or end user groups may be stored in the content repository 105 or in a separate database and/or storage medium in communication with the user interface 110. In an embodiment, the list of end users and/or end user groups may be available from the scheduling system 130 or another system, such as the registrar's office.

In an embodiment, selections of electronic content may be stored in a content repository 105. For example, the content repository 105 may store an indication of which electronic content has been designated for the associated end user by which content administrators. As such, the content repository 105 may include a complete inventory of electronic content selected for the associated end user.

In an embodiment, the content repository 105 and/or contributor content repository 140 may distribute 235 one or more pieces of electronic content that has been assigned to an end user to his or her associated end user device 120a-N. For example, a professor may decide that his students will use an electronic textbook and a freely available article for his course. The textbook may be available from a commercial database of licensable digital textbooks 125a-N, and the article may be available from a university file server 125a-N. The professor may select these two pieces of electronic content via the user interface 110. The content repository 105 may purchase the license fee for the textbook on behalf of the students enrolled in the class, and may forward the associated license costs to the university's bursar office 135 for billing.

Alternatively, the license costs for one or more electronic content items may have been prepaid. The content repository 105 may determine whether this is the case by cross-referencing an identifier of the selected electronic content, such as a name or unique code associated with the electronic content, with a list of electronic content for which the licenses have been prepaid. In an embodiment, if the license costs have been prepaid, the content repository 105 may determine license fees based on the number of copies that are distributed. For example, a university may prepay a license cost for a textbook. Thirty students may enroll in the course for which the textbook is assigned. The content repository 105 may determine each student's individual license cost by dividing the prepaid license cost by thirty students. The individual license costs may be forwarded to the university's bursar office for billing. It is understood that additional and/or alternate methods of determining license costs may be used within the scope of this disclosure.

In an embodiment, the content repository 105 may download and/or store selected electronic content. For instance, with respect to the above example, the content repository 105 may download the textbook from the commercially available database 125a-N and the article from the university file server 125a-N. In an embodiment, the content repository 105 may store, for one or more pieces of electronic content, an indication of to which end users the electronic content has been assigned. For example, the content repository 105 may store an end user's name, unique identifier, such as a student identification number, a social security number and/or the like.

In an embodiment, the content repository 105 and/or contributor content repository 140 may distribute 235 electronic copies of selected content to the end user devices 120a-N associated with the end users to whom the electronic content has been assigned. In an embodiment, the content repository 105 and/or contributor content repository 140 may automatically transmit or push electronic content to end user devices 120a-N. For instance, referring to the example above, the content repository 105 may transmit electronic copies of the textbook and the article to the end user device of each student enrolled in the professor's course.

In an embodiment, electronic content may be transmitted in compliance with one or more rights associated with the electronic content. A right may be a rule, restriction and/or the like that imposes limitations on how an electronic content item can be used by an end user. In an embodiment, one or more rights and an indication of one or more electronic content items to which the rights correspond may be stored in a rights repository 165. A rights repository 165 may be a storage medium or a portion thereof that is capable of storing electronic data. For example, a rights repository 165 may be one or more databases or other storage medium, such as RAM or ROM, of a computing device, a server and/or the like. In an embodiment, a rights repository 165 may be one or more databases or other storage medium, such as RAM or ROM, that is in communication with a computing device, a server and/or the like. In an embodiment, a rights repository 165 may be included in a content repository 105. Alternatively, a rights repository 165 may be in communication with a content repository 105.

For example, paid electronic content that is assigned to an end user may be associated with a right indicating that the paid electronic content cannot be copied. The rights repository 165 may store an indication that copying is prohibited as well as an indication of the paid electronic content to which this right corresponds. As such, paid electronic content items may be distributed to the end user's end user device 120a-N with anti-copying security in place. For example, a paid electronic content item may be encrypted. Only end user devices 120a-N belonging to end users who have been selected to receive the electronic content may be allowed to decrypt the electronic content. Such decryption may be accomplished via one or more decryption keys which may be downloaded to an end user device 120a-N before the encrypted electronic content is transmitted, simultaneously with the transmission of electronic content or after the electronic content is transmitted to an end user device. In an embodiment, hardware in the end user device 120a-N, including but not limited to firmware, chips, registers and/or the like may perform at least a portion of the decryption. The decryption of electronic content may occur invisibly to an end user.

In an embodiment, rights may be determined by a content publisher or other content distributor. For example, an electronic content item may be subject to digital rights management (DRM) protection, and may have DRM rights associated with it. DRM rights may be access control rights that impose limitations on how the electronic content can be used, accessed, modified and/or the like. If electronic content having DRM rights is selected, indications of the DRM rights and the associated electronic content may be stored in a rights repository 165. For example, a textbook requiring a license may downloaded from a content database 125a-N to the content repository 105. The rights repository 165 may be updated to reflect the textbook and the rights associated with the textbook. Before the textbook is distributed to one or more end user devices, the content repository 105 may access the rights repository to identify what rights are associated with the text book. The content repository 105 may distribute the textbook to one or more end user devices 120a-N in compliance with the associated rights.

In an embodiment, a content administrator may specify one or more rights for one or more pieces of electronic content and/or one or more end users. For example, a professor may specify that students in his history course be able to view a piece of electronic content for a certain period of time. This right may be communicated from the professor to the content repository 105 via the user interface 110. The content repository 105 may transmit an indication of the right and the associated electronic content item to the rights repository 165. The electronic content item may be downloaded to the students' end user devices 120a-N, but after the designated period of time expires, the electronic content item may be inaccessible to the students. In an embodiment, the electronic content item may be deleted or otherwise removed from the students' end user devices 120a-N. Alternatively, the electronic content item may remain on the students' end user devices 120a-N, but the students may be blocked from accessing such electronic content item.

In an embodiment, a content administrator may elect to have one or more electronic content items distributed to one or more end user devices 120a-N on a calendar-based distribution system. For example, a content administrator may assign a distribution date to one or more pieces of selected electronic content. The selected electronic content may be transmitted to the end user devices 120a-N of the assigned end users on the distribution date.

In an embodiment, the system 100 may include a calendar system 145. The calendar system 145 may be a part of the content repository 105 and/or the contributor content system 140. Alternatively, the calendar system 145 may reside on a computing device in communication with the content repository 105 and/or the contributor content system 140. In an embodiment, the calendar system 145 may be in communication with one or more end user devices 120a-N.

In an embodiment, one or more end users may have an associated calendar which they may modify using their end user devices 120a-N and/or other computing devices, such as a desktop computer, a laptop computer, a mobile device an/or the like. In an embodiment, the calendar system 145 may be a web-based application that an end user may access from any networked computing device. In an embodiment, a calendar may be unique to each end user. An end user may input entries into his or her calendar on certain days and/or times. For example, an end user may incorporate his class schedule into his calendar. An end user may also put other entries, such as events, tasks, meetings and/or the like on his calendar.

In an embodiment, a content administrator may use one or more entries on one or more calendars as the basis for identifying a group of end users to whom selected electronic content should be delivered. For example, a professor may assign a selected piece of electronic content to end users who have an entry for a review session on their calendar on a certain date and at a certain time. The selected piece of electronic content may be automatically transmitted to the end user devices 120a-N of these users, or it may be distributed at a certain time as specified by a content administrator.

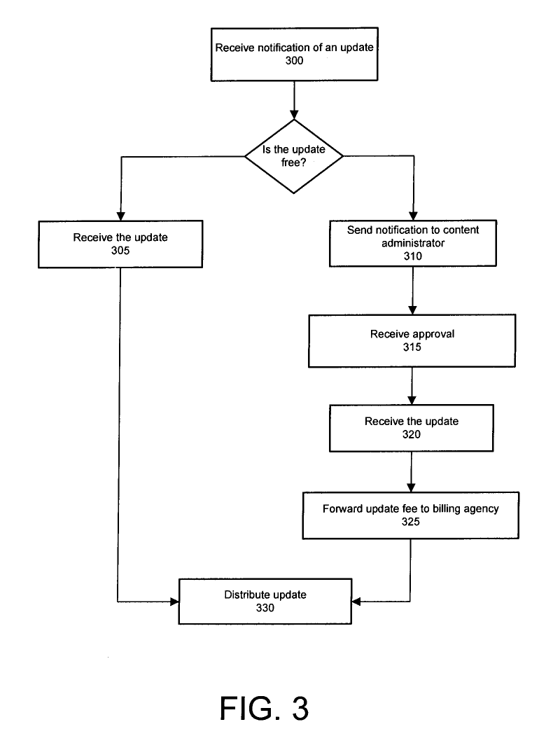

FIG. 3 illustrates an exemplary method of distributing one or more updates to electronic content according to an embodiment. In an embodiment, an update may be a modification to an electronic content item or a portion thereof. In an embodiment, the content repository 105 may distribute updates to electronic content. For example, a publisher may make available an update to a textbook that has already been purchased by the content repository 105 and downloaded to an end user device 120a-N.

In an embodiment, a content repository may receive 300 notification from a publisher or content database 125a-N may of the existence of an update for an electronic content item. In an embodiment, the notification may indicate whether the update is free or requires payment of an update fee. If the update is free, the content repository 105 may automatically receive 305 the update from a content database 125a-N. If an update fee is required, then the update may need to be approved by the content administrator who selected the electronic content to which the update corresponds. For example, a content database 125a-N may notify the content repository 105 when an update to an electronic content item is available. If an update fee applies to the electronic content item, the content repository 105 may send 310 a notification, such as an email, to the content administrator who selected the electronic content item to which the update corresponds. In an embodiment, the notification may ask the content administrator whether or not the update fee is approved. The content administrator may approve the update fee using the user interface 110, and such approval may be received 315 by the content repository. In an embodiment, the content repository 105 may receive 320 the update. In an embodiment, any approved update fees may be forwarded 325 to a billing agency 135 for billing. Updates received by the content repository 105 may be automatically distributed 330 to the end user devices that received the electronic content to which the update corresponds.

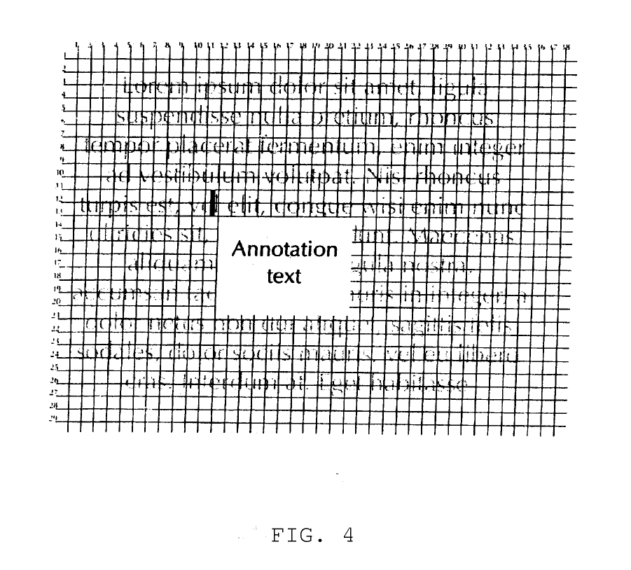

In an embodiment, an end user may make annotations to the electronic content that is downloaded to his or her end user device 120a-N. An annotation may be a modification to an electronic content item made by an end user. For example, an end user may highlight, underline, make notes to or otherwise annotate downloaded electronic content. FIG. 4 illustrates exemplary annotated text according to an embodiment. In an embodiment, an end user may annotate electronic content using his or her end user device 120a-N. An end user may use a keyboard or other input device in communication with the end user device 120a-N to annotate electronic content. In an embodiment, a stylus may operate with an end user device 120a-N. The stylus may be capable of electronically writing on a touch sensitive screen of the end user device 120a-N.

In an embodiment, annotations may be anchored and linked to the electronic content item to which they correspond. Text anchors may relate to a location where an annotation is placed in text in the electronic content item. Fore example, an annotation may be anchored between words, paragraphs, spaces and/or the like. In an embodiment, if an anchor position is relocated, the annotation may relocate accordingly.

In an embodiment, LL anchoring may be used to annotate electronic content. LL anchoring maps an annotation to a physical location based on an x,y grid pattern that is virtually overlaid at least a portion of a piece of electronic content. For example, when an annotation is placed, its location relative to the rest of the page (but independent of any text or images on the page) may be registered, thereby providing a text-independent anchor.

In an embodiment, if an anchor is lost or the text to which it was anchored is deleted or modified by an update, the presence of an LL anchor may be used to retain the location of the annotation for future reference. For example, when an end user makes an annotation to a piece of electronic content, an LL anchor may be created at the location of the annotation. If there is an update to a portion of the electronic content that is annotated, the update may be sent to the end user device and the electronic content may be changed to reflect the update. In an embodiment, an LL anchor in the original electronic content may be retained in the electronic content after the update has been applied. In an embodiment, an annotation may be located in the updated electronic content in the same location as it was in the original electronic content.

In an embodiment, annotations to electronic content may be transmitted to and/or stored on the content repository 105, contributor content repository 140 or other database or storage medium located remotely from an end user device 120a-N. As such, an end user's annotations and electronic content may be backed up in case the end user device 120a-N is lost, stolen or rendered inoperable. For example, a user may make annotations to a textbook that is stored on his end user device 120a-N. Periodically, the electronic content, including annotations, may be uploaded to and stored on a backend computing device, such as the content repository 105, contributor content repository 140 or other database or storage medium located remotely from an end user device 120a-N. In an embodiment, electronic content from an end user device 120a-N may be transmitted to the content repository 105, contributor content repository 140 or other database or storage medium located remotely from an end user device at certain times, such as every hour. Alternately, electronic content from an end user device 120a-N may be transmitted to the content repository 105, contributor content repository 140 or other database or storage medium located remotely from an end user device 120a-N at the initiation of the end user.

If the end user loses his end user device 120a-N, his electronic content, including the annotations he made to the electronic content, may be restored to a different end user device in accordance with the rights and/or privileges associated with the electronic content.

In an embodiment, an end user may link a portion of one electronic content item with a portion of the same and/or a different content item. In an embodiment, an end user may link portions of electronic content items by inserting a navigation element into a first portion of an electronic content item, and identifying a second portion of an electronic content item to which the first portion corresponds. In an embodiment, a navigation element may be an automated cross-reference to a portion of an electronic content item. The navigation element may be anchored to a portion of text, a picture, a page, a section and/or the like.

For example, an end user may create a summary of an article. The summary may be a Word document, and the article may be electronic content that was downloaded to the end user's end user device 120a-N from the content repository 105. In an embodiment, the user may insert a navigation element into a portion of the article that links that portion to the end user's summary. When the end user selects the navigation element in the article, the summary may be automatically displayed.

In an embodiment, end user created electronic content may be transmitted to and/or stored on the content repository 105, the contributor content repository 140 and/or other database or storage medium located remotely from an end user device 120a-N. As such, electronic content created by an end user may be backed up in case the end user device is lost, stolen or rendered inoperable. In an embodiment, end user created electronic content may be transmitted to the content repository 105, the contributor content repository 140 and/or other database or storage medium located remotely from an end user device 120a-N at certain times, such as every hour. Alternately, end user created electronic content may be transmitted to the content repository 105, the contributor content repository 140 and/or other database or storage medium located remotely from an end user device 120a-N at the initiation of the end user.

If the end user loses his end user device, electronic content that he or she created may be restored to a different end user device in accordance with the rights and/or privileges associated with the electronic content.

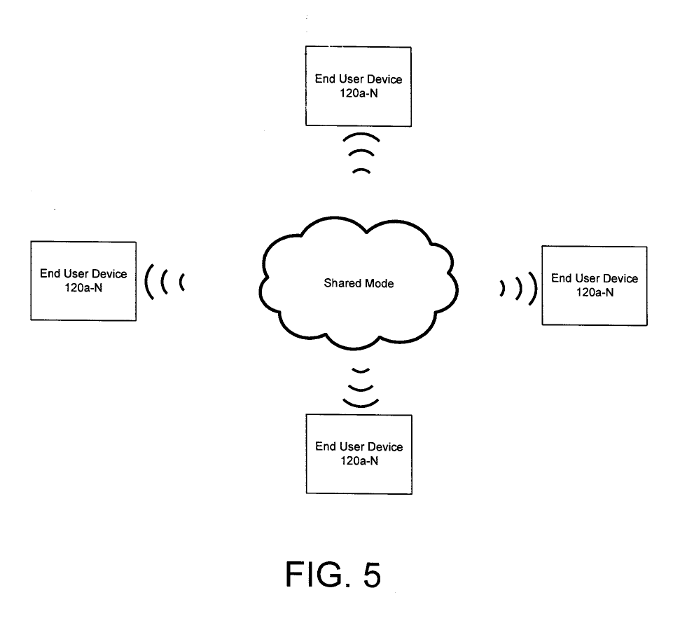

In an embodiment, an end user device 120a-N may be configured to operate in a shared mode. In an embodiment, shared mode may be a setting on an end user device 120a-N that an end user may turn on and off. Shared mode may be a localized, ad hoc connection between two or more end user devices 120a-N. When an end user device 120a-N is operating in shared mode, an end user may allow other end users to access certain electronic content that is stored on the end user's end user device 120a-N. FIG. 5 illustrates exemplary end user devices 120a-N operating in shared mode according to an embodiment.

In an embodiment, an end user may specify the devices 120a-N that are allowed to connect to his or her end user device. For instance, an end user may authorize end user devices 120a-N by identifying an end user associated with the end user device and/or a unique identifier associated with an end user device. For example, End User A may want to allow End User B to access his end user device 120a-N. End User A may authorize End User B to access his end user device 120a-N by providing his end user device with End User B's name and/or a unique identifier associated with End User B's device. End User A's device may use this information to locate and connect to End User B's device 120a-N.

For example, in shared mode, an end user may allow other end users to search, view, download and/or modify electronic content on the end user's device 120a-N. In an embodiment, only unlicensed electronic content may be accessed. For example, if a licensed textbook is stored on an end user device 120a-N, other end users may not search, view, download, modify or otherwise access the textbook when the end user device 120a-N is operating in shared mode. Unlicensed electronic content, such as free articles, handouts, end user created documents and/or the like may be accessible by other end users when the end user device 120a-N is operating in shared mode.

By way of example, shared mode may be utilized by students in a study group. One or more students may configure their end devices to operate in shared mode. For example, a student may use a graphical user interface to change an operating setting of the end user device 120a-N. In another embodiment, a student may press a button, flip a switch and/or the like to allow an end user device 120a-N to operate in shared mode. When the students' end user devices 120a-N operate in shared mode, the students may access each other's electronic content from their end user device. This may facilitate collaboration and the easy sharing of information.

In an embodiment, the system may include a home system 150. The home system 150 may be an Internet accessible storage system that may be synchronized with one or more end user devices 120a-N. The home system 150 may reside on a computer device, such as a server, a web server and/or the like. The home system may have a graphical user interface, and may be accessible via a URL or other Internet address. In an embodiment, a home system may be accessible from any computing device with an Internet connection.

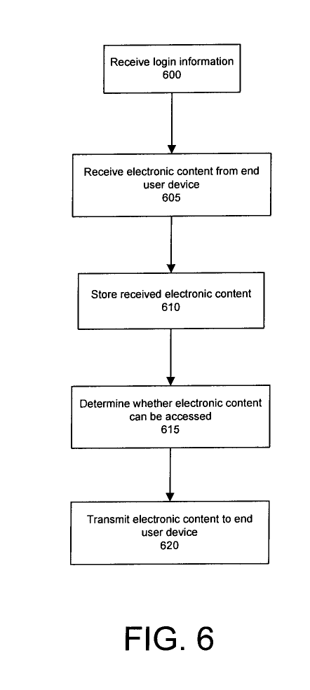

FIG. 6 illustrates an exemplary method of using the home system 150 according to an embodiment. In an embodiment, an end user may login to the home system 150 by providing a username, password and/or the like, which may be received 600 by the home system 150. End users may save, view and/or edit electronic content from an end user device using the home system 150. The home system 150 may communicate with one or more end user devices 120a-N via a wired and/or wireless interface. For example, an end user may dock his or her end user device 120a-N to a computing device, which may communicate with the home system 150.

In an embodiment, an end user device 120a-N may wirelessly communicate with the home system 150. The end user may initiate synchronization of the home system 150 and the end user device 120a-N. Alternatively, the home system 150 and end user device 120a-N may automatically synchronize at certain times.

At least a portion of the electronic content that is stored on an end user device 120a-N may be transmitted to the home system 150. The home system may receive 605 electronic content from an end user device 120a-N, and may store 610 the received electronic content. In an embodiment, the home system may store 610 the received electronic content in an account on the home system associated with the end user to whom the electronic content belongs. The electronic content that is transmitted may include electronic content that has been annotated. As such, an end user may be able to access the same electronic content that is on his or her end user device 120a-N on another computing device, such as a desktop computer, via the home system 150.

In an embodiment, an end user may be able to access electronic content that is stored the home system 150. In an embodiment, only free electronic content or electronic content that is end user created may be saved, viewed and/or edited using the home system 150. In an embodiment, the home system 150 may determine 615 whether electronic content that it has received from an end user device may be displayed, modified and/or otherwise accessed using the home system 150. For example, the home system may examine rights associated with the electronic content from the rights repository 165. In an embodiment, the home system may restrict and/or prohibit access to one or more electronic content items according to rights set forth in the rights repository 165. For example, the home system 150 may not display electronic content that is subject to a license. In an embodiment, the home system 150 may display only a portion of electronic content that is subject to a license. For example, if an end user has annotated a textbook, the annotation and a small portion of text from the textbook to which the annotation corresponds may be displayed. In comparison, if an end user annotates a free handout distributed by a professor, for example, the entire handout and annotations will be viewable and editable from the home system 150.

In an embodiment, an end user may annotate an electronic content item on the home system 150. These annotations may be received 605 by and saved 610 to the home system 150. In an embodiment, the annotations made to an electronic content item using the home system 150 may be transmitted 620 to the end user's end user device 120a-N in the next synchronization.

In an embodiment, the home system 150 may serve as a repository for homework assignments when used in an educational context. For example, a professor may distribute a homework assignment to students in the professor's course. The students may complete the homework assignment on their end user devices 120a-N, and may upload the completed homework assignment to the home system 150. In an embodiment, the students may elect to share the completed homework assignment with one or more other end users or other users of the home system 150. For example, a student may elect to share his completed homework assignment with his professor. The professor may access the completed homework assignment via the home system 150. In an embodiment, the professor may annotate the homework assignment using the home system 150. The annotated homework assignment may then be transmitted to the end user's end user device 120a-N.

In an embodiment, the home system 150 may provide an interface to an online store 155 where an end user may purchase electronic content. The online store 155 may be hosted by a web server or other computing device. In an embodiment, an end user may access the online store 155 through the home system 150, such as by clicking a URL or other link to the online store that is displayed in the home system. Alternatively, an end user may access the online store 155 by entering a URL or other Internet address in a browser.

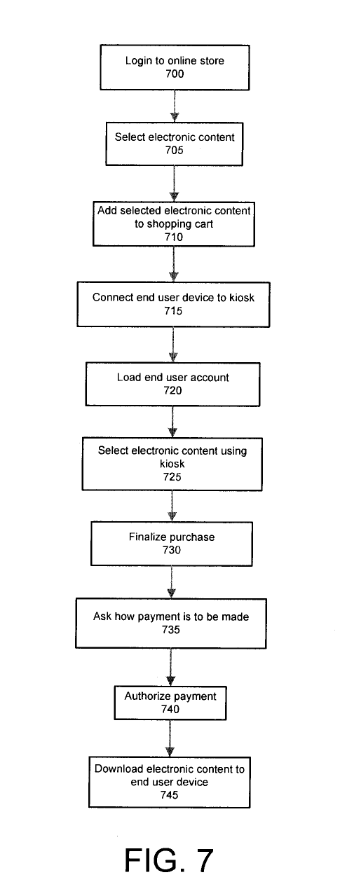

FIG. 7 illustrates an exemplary method of purchasing electronic content from an online store 155 according to an embodiment. In an embodiment, an end user may login 700 to the online store 155 by providing a username, password and/or the like. An end user may select 705 one or more electronic content items that the end user wants to purchase. The electronic content items may include textbooks, articles, supplements, study aides, books, magazines and/or the like. The selected electronic content items may be compiled and associated with the end user. For example, the selected electronic content items may be added 710 to a shopping cart or a purchase queue associated with the end user. In an embodiment, to finalize the purchase, an end user may connect 715 his or her end user device 120a-N to a kiosk 160. A kiosk 160 may be part of the system 100, and may be configured to communicate with one or more end user devices 120a-N. A kiosk 160 may include a computing device, a computer readable storage medium, a printing device and/or the like. A kiosk 160 may include a touch screen. In an embodiment, a kiosk 160 may include additional and/or alternate input means, such as a keyboard, a mouse and/or the like. A kiosk 160 may be stationed in a variety of locations. For example, in an educational environment, one or more kiosks 160 may be located in a university bookstore, student union, dormitory or other locations.

In an embodiment, a kiosk 160 may include a dock or port where an end user device 120a-N may be connected to the kiosk. When an end user docks his or her end user device 120a-N, the kiosk 160 may automatically load 720 the electronic content that the end user selected to purchase. Alternatively, the kiosk 160 may be configured to communicate wirelessly with an end user device 120a-N. For example, the kiosk 160 may be able to detect an end user device 120a-N when the end user device is within a certain range from the kiosk.

In an embodiment, the kiosk 160 may provide the end user, via a graphical user interface, with the option of completing or editing the end user's purchase. In an embodiment, if an end user had not previously selected electronic content items to purchase, he or she may select 725 electronic content using the kiosk 160. In an embodiment, a kiosk 160 may communicate with the online store to allow an end user to purchase electronic content via the kiosk 160.

In an embodiment, once an end user has selected electronic content to purchase, the end user may finalize 730 the purchase by selecting a button, a link and/or the like on the kiosk 160 or the kiosk's graphical user interface. In an embodiment, the kiosk may ask 735 the end user how payment will be made. Once payment has been authorized 740, the selected electronic content may be downloaded 745 to the end user's end user device 120a-N via the dock and/or port.

For example, an end user may select 725 a study guide to purchase from the online store 155 using a kiosk 160. The kiosk 160 may inform the end user that the cost of the selected electronic content is $19.99, and the end user may finalize 730 his or her selection. In an embodiment, the kiosk may ask 735 the end user whether the cost should be charged to a financial account associated with the end user, or whether the end user will be paying at the kiosk. If the end user indicates that the cost should be charged to an end user's financial account, the end user may be asked to provide an indication of authorization for the transaction, such as a signature. In an embodiment, the cost of the purchased electronic content may be forwarded to a billing agency 135, such as a university bursar office, for billing to the end user.

If the end user indicates that payment will be made at the kiosk 160, the kiosk may prompt the end user to provide a credit card, a debit card, a gift card and/or the like. A kiosk 160 may include a payment station that may be configured to process payment by an end user with a credit card, a debit card, a gift card and/or the like. For example, a kiosk 160 may have a card swipe device that an end user may use to render payment. The kiosk 160 may be in communication with one or more authorization entities, including but not limited to credit card companies, banks, authorization centers and/or the like. The kiosk 160 may transmit payment information it receives from an end user, such as the end user's name, address, account number, payment amount, pin number, electronic signature and/or the like to an authorization entity. The authorization entity may authorize the transaction, and transmit a notification that the transaction has been authorized to the kiosk 160. The kiosk 160 may print a receipt of the transaction for the end user. In an embodiment, after payment has been authorized 740, the purchased electronic content may be downloaded 745 to the end user's end user device 120a-N. In an embodiment, if payment is denied, the electronic content may not be downloaded to an end user device 120a-N.

In an embodiment, the system 100 may include a tracking system 170. The tracking system 170 may reside on a computer device, such as a server and web server and/or the like. The tracking system 170 may be in communication with one or more end user devices 120a-N and/or the home system 150. In an embodiment, the tracking system 150 may provide distribution and/or usage statistics. For example, the tracking system 150 may track how many of each electronic content item is selected by a content administrator, purchased, downloaded to an end user device 120a-N and/or the like over a period of time. In an embodiment, the tracking system 170 may gather anonymous information regarding usage of electronic content by end users of an end user device 120a-N. For example, the tracking system 170 may store metadata associated with one or more items of electronic content, which may be analyzed by statisticians and provided as periodical reports to publishers, administrators, advertisers, market analysts and/or the like. Exemplary information that may be gathered includes, but is not limited to, a number of times an electronic content or a portion of an electronic content item is accessed. For example, information regarding how often a book is opened and/or how often a chapter of the book is read may be gathered. In an embodiment, the tracking system 170 may gather information including but not limited to a number of annotations in an electronic content item, a number of annotations per portion of an electronic content item, an average length of annotations in an electronic content item, a number of times an end user operated his or her end user device in shared mode, how many other end users accessed annotations on an end user's end user device and/or the like.

In an embodiment, the system may include one or more contributor devices 175. A contributor device may be a computing device that may communicate with one or more end user devices 120a-N. In an embodiment, a contributor device may communicate with one or more end user devices using short range communication technology, such as Bluetooth and/or the like.

In an embodiment, a contributor device 175 may be used to distribute one or more electronic content items to one or more end user devices 120a-N. For example, a contributor device 175 may be located in a university classroom. In an embodiment, a contributor device 175 may be in communication with a computing device located in the classroom. For example, a contributor device 175 may be connected to a computing device, such as a desktop computer, a laptop computer, a notebook computer and/or other computing device. In an embodiment, a contributor device 175 may be connected to a computing device by a wired interface, such as a USB port and/or the like. Alternatively, a contributor device 175 may be wirelessly connected to a computing device. The contributor device 175 may communicate with one or more end user devices in the classroom.

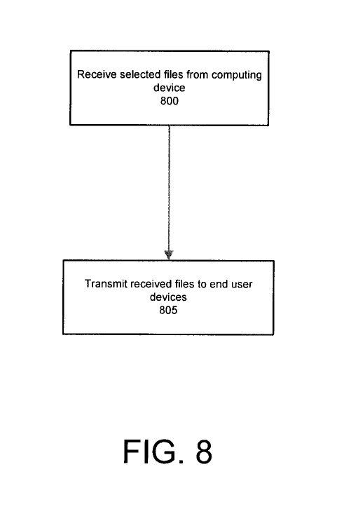

FIG. 8 illustrates an exemplary method of distributing electronic content using a contributor device 175 according to an embodiment. In an embodiment, a content administrator, such as a professor, may upload one or more electronic content items to the contributor device 175 via a computer device. For example, a professor may select one or more files stored on the computer device to transmit to a contributor device 175. The selected files may be transmitted to and received by 800 the contributor device 175. The contributor device 175 may transmit 805 the electronic content item to one or more end user devices 120a-N within a certain range of the contributor device. For example, a professor may upload a quiz to a contributor device 175 located in the professor's classroom. As such, the professor is able to electronically distribute course materials, thus reducing the amount of paper used by the professor and the university.

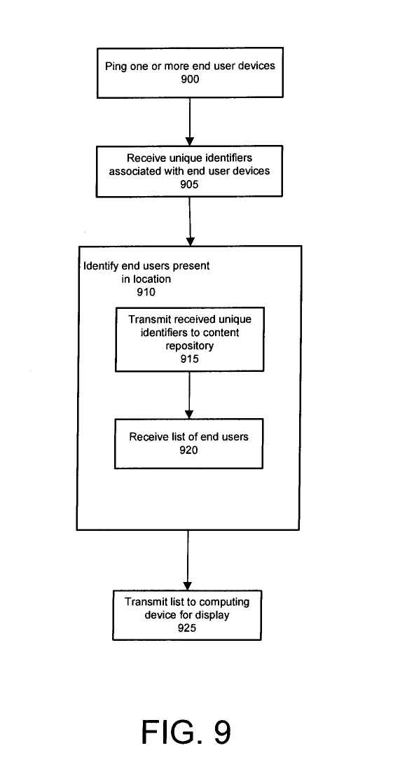

In an embodiment, a contributor device 175 may be used to track the presence of one or more end users at a certain location. FIG. 9 illustrates an exemplary method of tracking attendance according to an embodiment. For example, a contributor device 175 may be located in a university classroom, and may be used to take attendance for certain classes or other meetings held in that class room. In an embodiment, a contributor device 175 may ping 900 one or more end user devices 120a-N within a certain range of the contributor device. In response to the ping, the contributor device 175 may receive 905 unique identifiers associated with one or more end user devices 120a-N and/or one or more end users. The contributor device 175 may use the received unique identifiers to identify 910 the end users present at the location. For example, the contributor device 175 may transmit 915 the received unique identifiers to the content repository 105 where they may be cross-referenced against a list of unique identifiers associated with the end user devices 120a-N of the end users enrolled in the class. For example, the content repository 105 may communicate with a scheduling system 130 to obtain enrollment information, and may communicate with one or more end user accounts 115 to obtain unique identifiers associated with the students enrolled in the class. The content repository 105 may use this information to generate a list of students present in the classroom and/or missing from the classroom. This list may be transmitted to and received 920 by the contributor device 175, which may transmit 925 the information to the computing device in the classroom that is in communication with the contributor device. In an embodiment, the list may be displayed to the professor on the computing device in communication with the contributor device.

In an embodiment, a contributor device 175 may be used to enable and/or disable a black out mode for one or more end user devices 120a-N. During black out mode, one or more end users may be prevented from accessing one or more electronic content items on their end user devices 120a-N during a certain time period. For example, a professor may enable blackout mode during a test examination so the students in the class are unable to access any electronic content on their end user device 120a-N.

In an embodiment, blackout mode may be enabled through the use of a web browser on a computing device. For example, a professor may access an application on a web server or other computing device from a computing device in a classroom that is in communication with a contributor device 175. In an embodiment, the application may reside on the same computing device, server and/or the like on which the content repository 105 resides.

In an embodiment, a content administrator may make a selection via a web browser to enable blackout mode. For example a professor may select a class for which blackout mode should be enabled using a button, drop down or other menu. In an embodiment, the professor may make a selecting indicating that blackout mode should be enabled, such as by selecting a button, a drop down or an indication from another menu type. In an embodiment, the web browser may access a list of enrolled students for the selected class and determine the unique identifiers associated with the end user devices 120a-N of each of the enrolled students. Blackout mode may be enabled on the end user devices 120a-N corresponding to the unique identifiers.

In an embodiment, a content administrator may enable blackout mode in advance of an event. For example, a professor may specify a time in which blackout mode should be enabled. Blackout time may be automatically started at a designated start time, and may be automatically disabled at a designated end time. In an embodiment, blackout mode may be automatically disabled after a certain period of time from when blackout mode is enabled. For example, blackout mode may automatically be disabled three hours after it is enabled.

In an embodiment, blackout mode may be enabled and/or disabled with respect to one or more types of electronic content. For example, if a test being administered is open book but not open notes, a professor may enable blackout mode on one or more end user devices 120a-N with respect to notes such that the students taking the test are only able to access the electronic textbook for the course. Similarly, if a test being administered is open notes but closed book, a professor may enable blackout mode on one or more end user devices 120a-N with respect to books such that students taking the test are prohibited from accessing books on their end user devices. In an embodiment, a time period associated with black out mode may be specified by a content administrator. For example, a professor may enable blackout mode for the duration of an exam, such as a one-hour period of time.

In an embodiment, an contributor application that performs one or more functions of the contributor device 175 may reside on a web server and/or other computing device. In an embodiment, a content administrator may be able to distribute electronic content to end users in a certain location, track the presence of end users in a certain location and/or enable and/or disable blackout mode with respect to one or more end user devices without having a contributor device present in the location. In an embodiment, a content administrator may login to a contributor application via a computing device such as a laptop computer, a mobile computing device and/or the like by providing a username, password, biometric and/or the like. The content administrator may upload to the contributor application one or more electronic content items, which may be transmitted to one or more end user devices via a wireless network. For example, a professor may upload a class agenda to the contributor application. The professor may specify to which class members the agenda is to be distributed. The contributor application may transmit the class agenda to one or more end user devices of one or more end users enrolled in the class via one or more wireless access points located in the classroom. For example, the contributor application may communicate with a scheduling system 130 to determine one or more end users enrolled in a certain class, and may transmit the class agenda to those end user's devices.

As another example, a professor may login to a contributor application and request that attendance be taken at a certain time. In an embodiment, a contributor application may communicate with one or more wireless access points in a certain location. For example, a contributor application may communicate with one or more wireless access points in a classroom. The wireless access points may ping one or more end user devices within a certain range of the wireless access point. The wireless access points may receive unique identifiers associated with the end user devices within range of the wireless access points. These unique identifiers may be transmitted to the contributor application, which may use the received unique identifiers to identify the end users present at the location. For example, the wireless access points may transmit the received unique identifiers to contributor application which may cross-reference the received unique identifiers against a list of unique identifiers associated with the end user devices 120a-N of the end users enrolled in the class. For example, the content application may communicate with a content repository 105 and/or a scheduling system 130 to obtain enrollment information, and may communicate with one or more end user accounts 115 to obtain unique identifiers associated with the students enrolled in the class. This information may be transmitted to a computing device where it may be viewed by the professor or other content administrator.

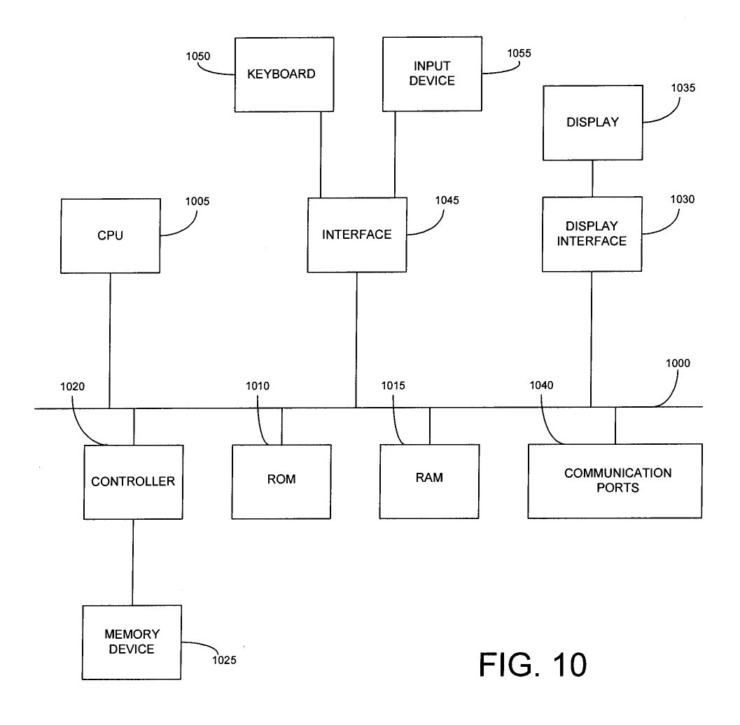

FIG. 10 depicts a block diagram of exemplary internal hardware that may be used to contain or implement program instructions according to an embodiment. A bus 1000 serves as the main information highway interconnecting the other illustrated components of the hardware. CPU 1005 is the central processing unit of the system, performing calculations and logic operations required to execute a program. Read only memory (ROM) 1010 and random access memory (RAM) 1015 constitute exemplary memory devices.

A controller 1020 interfaces with one or more optional memory devices 1025 to the system bus 1000. These memory devices 1025 may include, for example, an external or internal DVD drive, a CD ROM drive, a hard drive, flash memory, a USB drive or the like. As indicated previously, these various drives and controllers are optional devices.

Program instructions may be stored in the ROM 1010 and/or the RAM 1015. Optionally, program instructions may be stored on a tangible computer readable storage medium such as a hard disk, compact disk, a digital disk, flash memory, a memory card, a USB drive, an optical disc storage medium, such as Blu-ray™ disc, and/or other recording medium.

An optional display interface 1030 may permit information from the bus 1000 to be displayed on the display 1035 in audio, visual, graphic or alphanumeric format. Communication with external devices may occur using various communication ports 1040. An exemplary communication port 1040 may be attached to a communications network, such as the Internet or an intranet.

The hardware may also include an interface 1045 which allows for receipt of data from input devices such as a keyboard 1050 or other input device 1055 such as a mouse, a joystick, a touch screen, a remote control, a pointing device, a video input device and/or an audio input device.

An embedded system may optionally be used to perform one, some or all of the operations described herein Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for distributing electronic content, the system comprising:
a content repository comprising one or more electronic content items, wherein the content repository is in communication with one or more content databases;
a user interface in communication with the content repository, wherein the user interface is configured to receive a selection from a content administrator of:
one or more electronic content items available from the one or more content databases, and
one or more end users to whom the selected electronic content items are assigned; and
one or more end user devices in communication with the content repository, wherein each end user device is associated with an end user and an end user account, wherein each end user device is configured to receive the selected electronic content items that are assigned to the corresponding end user from the content repository.

2. The system of claim 1, wherein the content repository is configured to download the selected electronic content items from the one or more content databases.

3. The system of claim 1, wherein the content repository is configured to:
receive notification from one or more content databases that the selected content item requires a license fee;
in response to the license fee not being prepaid, authorize payment of the license fee;
download the selected electronic content item from the content database; and
transmit notification of the license fee to a billing agency for billing.

4. The system of claim 1, wherein the content repository is configured to:
receive notification from one or more content databases that the selected content item requires a license fee;
in response to the license fee being prepaid, download the selected electronic content item from the content database;
determine a number of end user devices to which the selected electronic content item will be distributed;
determine a cost associated with the selected electronic content item by dividing the license fee by the number of end user devices to which the selected electronic content item will be distributed; and
transmit notification of one or more of the license fee and the cost to a billing agency for billing.

5. The system of claim 1, further comprising a contributor content repository in communication with the user interface and the one or more end user devices, wherein the contributor content repository comprises one or more electronic content items supplied by one or more content administrators that do not require a license, wherein the user interface is further configured to receive a selection from the content administrator of:
one or more electronic content items available from the contributor content repository; and
one or more end users to whom the selected electronic content items from the contributor content repository are assigned,
wherein the contributor content repository is configured to distribute to the electronic content items selected from the contributor content repository to the end user devices associated with the one or more end users to whom the electronic content items are assigned.

6. The system of claim 1, wherein the content repository is configured to receive from the user interface:
the selection of the one or more electronic content items available from the one or more content databases; and
the selection of the one or more end users to whom the selected electronic content items are assigned,
wherein the content repository is configured to distribute the selected electronic content items to the end user devices associated with the selected end users.

7. The system of claim 6, wherein the content repository is configured to transmit the selected electronic content items to the end user devices associated with the selected end users in compliance with one or more rights associated with the selected electronic content items.

8. The system of claim 1, wherein the content repository is configured to receive a distribution date associated with the selected electronic content items from the user interface, wherein the content repository is configured to distribute the selected electronic content items to the end user devices associated with the one or more end users to whom the selected electronic content items are assigned on the distribution date.

9. The system of claim 1, wherein the content repository is configured to receive an indication of a calendar entry from the user interface, wherein the content repository is configured to access a calendar system to identify one or more end users having the calendar entry on their associated calendars, wherein the content repository is configured to distribute the selected electronic content items to the end user devices associated with the one or more identified end users.

10. A system of distributing electronic content, the system comprising:
a content repository comprising one or more electronic content items, wherein the content repository is in communication with one or more content databases; and
an end user device in communication with the content repository, wherein the end user device is associated with an end user and an end user account, wherein the end user device is configured to receive selected electronic content items from the content repository, wherein the selected electronic content items are assigned to the end user by a content administrator.

11. The system of claim 10, wherein the content repository is configured to:
download the one or more electronic content items from the one or more content databases, wherein the content databases comprise one or more of a commercial database, a free database and a fileserver; and
automatically distribute the downloaded electronic content items to the end user device.

12. The system of claim 11, wherein the content repository is configured to automatically distribute the downloaded electronic content items to the end user device in compliance with one or more rights associated with the electronic content items.

13. The system of claim 11, wherein the content repository is configured to:
determine whether the one or more electronic content items have a license associated with their use;
for each electronic content item having a license associated with its use:
distribute an encrypted version of the electronic content item to the end user device, and
distribute a decryption key capable of decrypting the encrypted version of the electronic content item to the end user device.

14. The system of claim 10, wherein the end user device is configured to allow the end user to annotate at least a portion of the received electronic content items.

15. The system of claim 14, wherein the end user device is configured to transmit one or more annotated electronic content items to the content repository.

16. The system of claim 10, wherein the end user device is configured to:
receive an update corresponding to an electronic content item already received by the end user device; and
update the corresponding electronic content item with the received update such that any annotations having an LL anchor that is present in the corresponding electronic content item are maintained when the update is applied.

17. The system of claim 10, wherein the content repository is configured to:
receive a notification from a content database that an update corresponding to an original electronic content item that has already received by the content repository and distributed to the end user device is available,
in response to the notification comprising an update fee associated with the update:
notify a content administrator who selected the original electronic content item of the update and the update fee,
in response to receiving approval from the content administrator:
pay the update fee,
forward the update fee to a billing agency for billing, and
automatically distribute the update to the end user device.

18. The system of claim 10, wherein the content repository is configured to:
receive a notification from a content database that an update corresponding to an original electronic content item that has already received by the content repository and distributed to the end user device is available,
in response to the notification not comprising an update fee associated with the update, automatically distribute the update to the end user device.

19. The system of claim 10, wherein the end user device is configured to operate in a shared mode, wherein one or more other end user devices are capable of accessing one or more electronic content items on the end user device when the end user device operates in shared mode.

20. A system for distributing electronic content, the system comprising:
a content repository comprising one or more educational electronic content items, wherein the content repository is in communication with one or more content databases;
a contributor content repository comprising one or more electronic content items supplied by one or more professors that do not require a license;
a user interface in communication with the content repository and the contributor content repository, wherein the user interface is configured to receive a selection from a professor of:
one or more educational electronic content items available from one or more of the content databases and the contributor content repository, and
one or more students to whom the selected electronic content items are assigned; and
one or more end user devices in communication with the content repository and the contributor content repository, wherein each end user device is associated with a student and a student account, wherein each end user device is configured to receive the selected educational electronic content items that are assigned to the corresponding student from one or more of the content repository and the contributor content repository.

21. A system for distributing electronic content, the system comprising:
a content repository comprising one or more electronic content items, wherein the content repository is in communication with one or more content databases; and
a user interface in communication with the content repository, wherein the user interface is configured to receive a selection from a content administrator of:
one or more electronic content items available from the one or more content databases, and
one or more end users to whom the selected electronic content items are assigned;
wherein the content repository is configured to transmit the selected content items to one or more end user devices.
